(19) United States
(12) Patent Application Publication
(10) Pub. No.: US 2019/0013680 A1
(43) Pub. Date: Jan. 10, 2019

(54) PARALLEL BATTERY EQUALIZATION DEVICE AND METHOD

(71) Applicant: EcoFlow Technology Limited, Shenzhen (CN)

(72) Inventors: Fan ZHENG, Shenzhen (CN); Mingze Ma, Shenzhen (CN)

(21) Appl. No.: 15/807,091

(22) Filed: Nov. 8, 2017

(30) Foreign Application Priority Data
Jul. 5, 2017 (CN) 201710544135.8

(51) Int. Cl. H02J 7/00

(52) U.S. Cl. CPC H02J 7/0019

(57) ABSTRACT

The present disclosure provides a parallel battery equalization device. A parallel battery equalization device includes a battery module including a plurality of battery packs and a plurality of parallel branches coupled to the battery packs, respectively, a switch module, a control module and a microprocessor. The switch module includes at least one switch transistor, and each switch transistor is coupled one parallel branch. The control module includes at least one pulse width modulation (PWM) drive control circuit. Each PWM drive control circuit is electrically coupled to the microprocessor. The present disclosure also provides a parallel battery equalization method.

### CROSS REFERENCE TO RELATED APPLICATION

This application claims priority to Chinese Patent Application No. 201710544135.8, entitled “ PARALLEL BATTERY EQUALIZATION DEVICE AND METHOD” filed on Jul. 5, 2017, the contents of which are expressly incorporated by reference herein in its entirety.

### FIELD OF THE INVENTION

The present disclosure relates to a field of battery technology, and more particularly relates to a parallel battery equalization device and a parallel battery equalization method.

### BACKGROUND OF THE INVENTION

The capacity of an existing single battery is limited, the conventional way of expanding the battery capacity is to adopt a plurality of parallel batteries. By adopting the plurality of parallel batteries, the overall capacity of the battery can be improved, thereby increasing the usage time of the battery. However, the capacity of the battery is uncertain before the parallel connection, thus the battery capacity difference between the batteries may be great. Since the inner core resistance of the battery is relatively small, if the battery is in parallel directly, the charging current will be excessive for battery having low capacity, which is easy to cause damage to the battery.

### SUMMARY

According to various embodiments of the present disclosure, a parallel battery equalization device and a parallel battery equalization method are provided.

A parallel battery equalization device includes a battery module including a plurality of battery packs and a plurality of parallel branches coupled to the battery packs, respectively; a switch module including at least one switch transistor; a control module including at least one pulse width modulation (PWM) drive control circuit; and a microprocessor. Each switch transistor is coupled one parallel branch, the parallel branch is conductive when the switch transistor is turned on, and the coupled parallel branch is cut off when the switch transistor is turned off. A control terminal of each switch transistor is electrically coupled to one PWM drive control circuit; and the PWM drive control circuit is used to control a conduction duty cycle of the switch transistor. The microprocessor is electrically coupled to each PWM drive control circuit, respectively. The microprocessor is used to acquire a real-time current of each parallel branch. The microprocessor controls a real-time conduction duty cycle of the switch transistor via the PWM drive control circuit according to the real-time current, such that the real-time current does not exceed a maximum charging current allowed by the battery pack at both ends of the parallel branch.

A parallel battery equalization method incudes: acquiring initial voltages of a plurality of parallel battery packs; regarding two battery packs having the highest voltage as a first battery pack and a second battery pack; obtaining a maximum charging current allowed by the first battery pack and the second battery pack; acquiring a real-time current of the parallel branch between the first battery pack and the second battery pack; acquiring a real-time conduction duty cycle of switch transistor disposed on the parallel branch between the first battery pack and the second battery pack according to the maximum charging current and the real-time current; adjusting a conductive state of the switch transistor according to the real-time conduction duty until the first battery pack and the second battery pack achieve a state of charge (SOC) equalization; and regarding the first battery pack and the second battery pack as a battery pack unit, and repeating the aforementioned steps until all the parallel battery packs achieve the SOC equalization.

The details of one or more embodiments of the disclosure are set forth in the accompanying drawings and the description below. Other features, objects, and advantages of the disclosure will become apparent from the description, the drawings, and the claims.

### BRIEF DESCRIPTION OF THE DRAWINGS

The above objects, features and advantages of the present disclosure will become more apparent by describing in detail embodiments thereof with reference to the accompanying drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a parallel battery equalization device according to an embodiment;

FIG. 2 is a schematic diagram of a parallel battery equalization device according to an embodiment;

FIG. 3 is a schematic diagram of a parallel battery equalization device according to another embodiment; and

FIG. 4 is a flowchart of a parallel battery equalization method according to an embodiment.

### DETAILED DESCRIPTION OF THE EMBODIMENTS

Embodiments of the invention are described more fully hereinafter with reference to the accompanying drawings, some embodiments of the present disclosure are shown in the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the present disclosure to those skilled in the art.

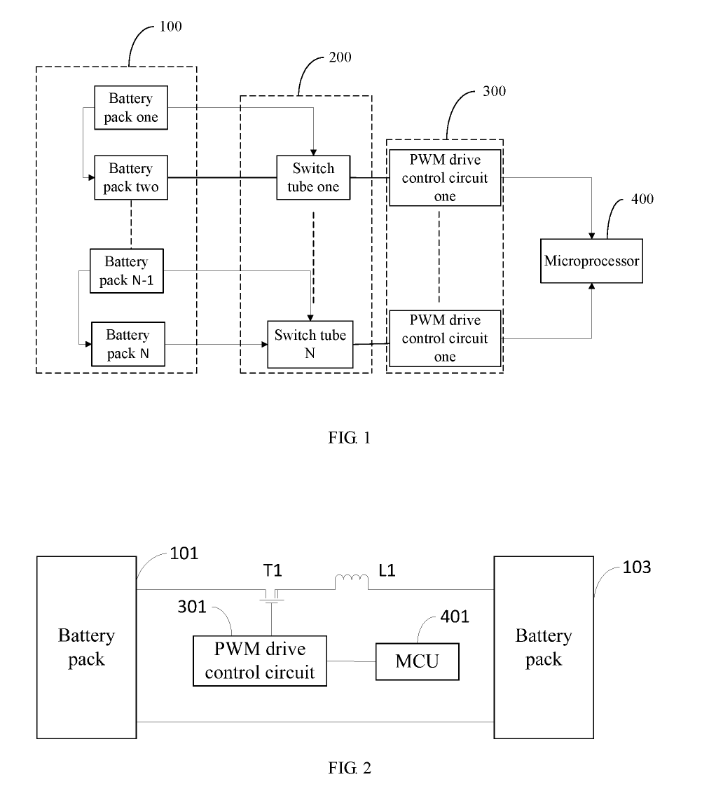

As shown in FIG. 1, a parallel battery equalization device according to an embodiment includes a battery module 100, a switch module 200, a control module 300, and a microprocessor 400. The battery module 100 includes a plurality of battery packs and a plurality of parallel branches coupled to the battery packs. The switch module 200 is electrically coupled to the battery module 100. The switch module 200 is used to control conduction of a current on each parallel branch in the battery module 100. The switch module 300 is electrically coupled to the battery module 100. The control module 300 is used to control a conductive state of each switch in the switch module 200. The microprocessor 400 is used to acquire a voltage of each battery pack in battery module 100. The microprocessor 400 is further used to acquire a real-time current of each branch. The microprocessor 400 controls the conductive state of each switch via the control module 300 according to the acquired voltage and the real-time current, so as to adjust conduction current of each parallel branch.

The battery module 100 includes a plurality of parallel battery packs. The switch module 200 includes at least one switch transistor. The control module 300 includes at least one pulse width modulation (PWM) drive control circuit. Each parallel branch in the battery module 100 is coupled to the switch transistor. The parallel branch is conductive when the switch transistor is turned on, and the parallel branches is cut off when the switch transistor is turned off. A control terminal of each switch transistor is electrically coupled to the PWM drive control circuit. In the illustrated embodiment, the switch transistor is a metal oxide semiconductor (MOS) switch transistor. Each PWM drive control circuit in the control module 300 is used to control a real-time conduction duty cycle of the switch transistor corresponding to the switch module 200.

The microprocessor 400 is electrically coupled to each PWM drive control circuit in the control module 300, respectively. The microprocessor 400 is used to acquire the real-time current of each parallel branch in the battery module 100. The microprocessor 400 adjusts a real-time conduction duty cycle of the corresponding switch transistor by controlling the corresponding PWM drive control circuit according to the real-time current of each parallel branch, such that the real-time current of the parallel branch does not exceed a maximum charging current allowed by the battery pack at both ends of the parallel branch. In the illustrated embodiment, the microprocessor controls the switch transistor of the corresponding parallel branch to perform initial conduction at a preset duty cycle via the PWM drive control circuit. The microprocessor 400 acquires the real-time current of each parallel branch in the battery module 100, and makes a ratio operation between the maximum charging current of the parallel branch and the real-time current of the parallel branch, and then multiplies an operation result value and the preset duty cycle to obtain an operation result value, i.e., the real-time conduction duty cycle of the switch transistor on the parallel branch. The microprocessor 400 controls the conductive state of the switch transistor of the corresponding parallel branch according to the real-time conduction duty cycle, thereby controlling the real-time current of the parallel branch not to exceed the maximum charging current allowed by the parallel branch. In the process of controlling the switch transistor to perform the initial conduction at the preset duty cycle via the microprocessor 400, the preset duty cycle can be set according to an actual situation. In the illustrated embodiment, the preset duty cycle is 1%. In an alternative embodiment, the preset duty cycle can be other preset values. As long as the switch transistor is conductive at the preset duty cycle, it is necessary that the current of the parallel branch does not exceed the maximum charging current of the battery pack at both ends of the parallel branch.

According to the aforementioned parallel battery equalization device, each parallel branch in the battery module 100 is coupled to one switch transistor. Each PWM drive control circuit in the control module 300 controls the conduction duty cycle of the switch transistor in the switch module 200, respectively. The microprocessor 400 acquires the real-time current of each parallel branch, and controls the real-time conduction duty cycle of the switch transistor on the corresponding parallel branch via the corresponding PWM drive control circuit according to the real-time current of each parallel branch, thereby controlling a real-time conduction current of the corresponding parallel branch. According to the aforementioned parallel battery equalization device, the real-time conduction duty cycle of the switch transistor on the corresponding parallel branch can be adjusted according to the real-time current of the parallel branch. Thus, the charging current on the parallel branch is controlled, and the damage of the battery caused by the excessive charging current is avoided when performing a state of charge (SOC) equalization to the parallel battery pack.

In the illustrated embodiment, the microprocessor 400 is further used to acquire an initial voltage of each battery pack in battery module 100. The microprocessor 400 determines a parallel battery pack which is performed SOC equalization firstly according to the initial voltage of each battery pack in battery module 100. After the SOC equalization of the parallel battery pack is completed, it is served as a new battery pack and will be performed SOC equalization with another battery pack. At the same time, the microprocessor 400 can also control the preset duty cycle of the corresponding switch transistor via the PWM drive control circuit in the control module 300 according to the initial voltage of the battery pack which has been performed SOC equalization, so as to control the conduction of the switch transistor at the preset duty cycle. Specifically, the microprocessor 400 make a subtraction operation between initial voltages across the battery packs at both ends of the parallel branch, and make a ratio operation between an operation result value and the internal resistance of the charged battery pack on the parallel branch to obtain a first operation value. Then, the microprocessor 400 makes a ration operation between the maximum charging current and the first operation value to obtain an operation result value, i.e., the preset duty cycle of the switch transistor. Assuming that the voltages across the battery packs at both ends of the parallel branch are V1 and V2, the internal resistance of the charged battery pack (voltage is V1) is R1 and the maximum charging current is I1max. Thus, the preset duty cycle can be calculated as a1=I1max/[(V2-V1)/r1].

Specifically, the process of performing SOC equalization to the parallel battery pack is: the microprocessor 400 acquire the initial voltage of each battery pack in the battery module 100, firstly, and the microprocessor 400 determines two parallel battery packs which are performed SOC equalization firstly according to the initial voltage of each battery pack. Then the microprocessor 400 makes the subtraction operation to initial voltages of the two parallel battery packs, and make the ratio operation between a subtraction operation result value and the internal resistance of the charged battery pack on the parallel branch to obtain the first operation value. Then, the microprocessor 400 makes the ration operation between the maximum charging current and the first operation value to obtain the operation result value, i.e., the preset duty cycle of the switch transistor on the parallel branch of the two parallel battery packs. The switch transistor on the parallel branch is conductive at the preset duty cycle. After the parallel branch is conductive, the microprocessor 400 acquires the real-time current on the parallel branch and makes the ratio operation between the maximum charging current and the real-time current, and then multiplies the operation result value with the preset duty cycle. The final product operation result value is the real-time conduction duty cycle of the switch transistor. The microprocessor 400 controls the real-time conduction current of the parallel branch by adjusting the real-time conduction duty cycle of the switch transistor, such that the real-time conduction current of the parallel branch does not exceed the maximum charging current. Therefore, the damage of the battery caused by the excessive charging current is avoided when performing the SOC equalization to the parallel battery pack.

In the illustrated embodiment, the parallel battery equalization device further includes a plurality of inductors. Each battery pack in the battery module 100 is coupled to the inductor. The inductor on the parallel branch can filter the charging current between the parallel battery packs to prevent excessive charging current occurring in the parallel branch, thereby avoiding the damage of the battery caused by the excessive charging current when performing the SOC equalization to the parallel battery pack.

As shown in FIG. 2, according to an embodiment, the battery module 100 includes two parallel battery packs, i.e., a battery pack 101 and a battery pack 103. The switch module 200 includes a switch transistor T1. The control module 300 includes a PWM drive control circuit 301. The switch transistor T1 is coupled to the parallel branch of the battery pack 101 and the battery pack 103. A control terminal of the switch transistor T1 is electrically coupled to the PWM drive control circuit 301. The PWM drive control circuit 301 is used to control a conduction duty cycle of the switch transistor T1. The microprocessor MCU401 is used to acquire initial voltages of the battery pack 101 and the battery pack 103, and acquire a real-time current on the parallel branch of the battery pack 101 and the battery pack 103. The microprocessor MCU401 controls the conduction duty cycle of the switch transistor T1 via the PWM drive control circuit 301 according to the acquired initial voltages and the real-time current. In the illustrated embodiment, the microprocessor MCU401 acquires the initial voltages of the battery pack 101 and the battery pack 103 firstly, then the microprocessor MCU401 makes a subtraction operation between the initial voltages of the first battery 101 and the battery pack 103. The microprocessor MCU401 make a ratio operation between a subtraction operation result and an internal resistance of the charged battery pack. The microprocessor MCU401 makes a ratio operation between a charging current value of the charged battery pack and a ratio operation result value to obtain a preset duty cycle of the switch transistor T1. After the switch transistor T1 is conductive at the preset duty cycle, the microprocessor MCU401 acquires the real-time current on the parallel branch of the battery pack 101 and the second battery pack 103. The microprocessor MCU401 outputs a real-time conduction duty cycle of the switch transistor T1 and controls the switch transistor T1 to be conducted at the output real-time conduction duty cycle via the PWM drive control circuit 301 according to the acquired the real-time current and the maximum charging current. Specifically, assuming that the real-time current on the parallel branch is I, the maximum charging current is Imax, and the preset duty cycle of the switch is a2. The real-time conduction duty cycle a output by the microprocessor MCU401 is calculated as: a=(Imax/I)*a2. In the illustrated embodiment, the preset duty cycle a2 is a preset value, and the preset value is 1%. In an alternative embodiment, the preset duty cycle a2 may also be the preset duty cycle obtained by the aforementioned initial voltages of the battery pack 101 and the battery pack 103.

In the illustrated embodiment, the inductor L1 is also coupled to the parallel branch of the battery pack 101 and the battery pack 103. The inductor L1 filters the current on the parallel branch of the battery pack 101 and the battery pack 103, so as to prevent a large current from occurring in the parallel branch, thereby protecting the battery pack 101 and the battery pack 103.

In the process of SOC equalization of the battery pack 101 and the battery pack 103, the charging current is dynamic. The microprocessor MCU401 acquires the real-time current when the battery pack 101 and the battery pack 103 are charged in parallel, and adjusts the conduction duty cycle of the switch transistor T1 according to the real-time current. Such that the charging current does not exceed a safety charging current of the charged battery pack when the battery pack 101 and the battery pack 103 are in the process of parallel equalization. Therefore, the damage of the battery caused by the excessive charging current is avoided when performing the SOC equalization to the parallel battery pack.

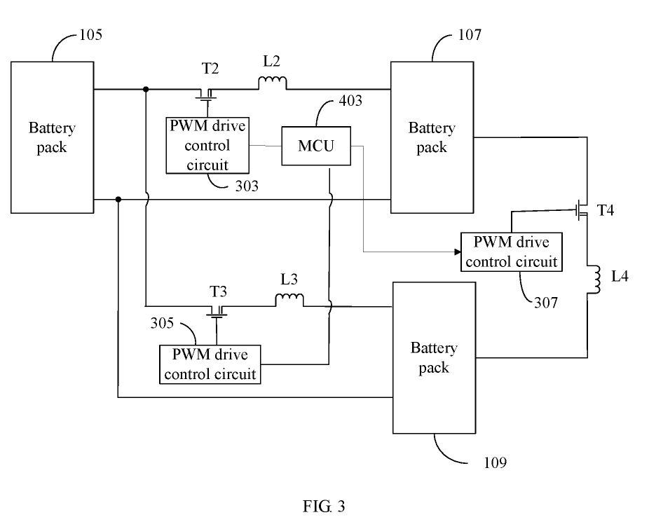

As shown in FIG. 3, according to an embodiment, the battery module 100 includes three battery packs, i.e., a battery pack 105 and a battery pack 107, and a battery pack 109. The switch module 200 includes a switch transistor T2, a switch transistor T3, and a switch transistor T4. The control module 300 includes a PWM drive control circuit 303, a PWM drive control circuit 305, and a PWM drive control circuit 307. The switch transistor T2 is coupled to the parallel branch of the battery pack 105 and the battery pack 107. A control terminal of the switch transistor T2 is electrically coupled to the PWM drive control circuit 303. The PWM drive control circuit 303 is used to control a conduction duty cycle of the switch transistor T2. The switch transistor T3 is coupled to the parallel branch of the battery pack 105 and the battery pack 109. A control terminal of the switch transistor T3 is electrically coupled to the PWM drive control circuit 305. The PWM drive control circuit 305 is used to control a conduction duty cycle of the switch transistor T3. The switch transistor T2 is coupled to the parallel branch of the battery pack 105 and the battery pack 107. A control terminal of the switch transistor T4 is electrically coupled to the PWM drive control circuit 307. The PWM drive control circuit 307 is used to control a conduction duty cycle of the switch transistor T4. A microprocessor MCU403 is used to acquire initial voltages of the battery pack 105, the battery pack 107, and the battery pack 109, and acquire a real-time current on each parallel branch consisting of the battery pack 105, the battery pack 107, and the battery pack 109. The microprocessor MCU403 controls a real-time conduction duty cycle of the corresponding switch transistor via each PWM drive control circuit according to the acquired initial voltages and the real-time current. Specifically, the microprocessor MCU403 determines two battery packs having the highest voltage according to the initial voltage of each battery pack and performs a equalization charging to the two battery packs. After the SOC equalization of the two battery packs having the highest voltage is completed, it is served as a new battery pack unit and will be performed SOC equalization with another battery pack. The manner in which the parallel battery pack is performed SOC equalization is the same as that of the two parallel battery packs in the embodiment of FIG. 2, and will not be described in detail here.

In the illustrated embodiment, each parallel branch in the parallel branch consisting of the battery pack 105, the battery pack 107, and the battery pack 109 is coupled to a inductor L2, a inductor L3, and a inductor L4, respectively. The inductor L2 is coupled to the parallel branch of the battery pack 105 and the battery pack 107. The inductor L3 is coupled to the parallel branch of the battery pack 105 and the battery pack 109. The inductor L4 is coupled to the parallel branch of the battery pack 107 and the battery pack 109. The inductor L2, the inductor L3, and the inductor L4 filter the current on each parallel branch respectively, so as to prevent a excessive current from occurring on the parallel branch, thereby protecting the parallel battery packs.

In an alternative embodiment, the number of parallel batteries in the battery module 100 may also exceed 3. Accordingly, each parallel branch is coupled to a switch transistor, and a control terminal of each switch transistor is coupled to the PWM drive control circuit by which to adjust the duty cycle of the switch transistor. The microprocessor MCU400 is used to acquire initial voltage of each battery pack, and acquire a real-time current on each parallel branch. The microprocessor MCU400 adjusts a conduction duty cycle of the corresponding switch transistor by the corresponding PWM drive control circuit according to the acquired voltage of the battery pack and the real-time current of each parallel branch. Such that the charging current of the branch is in the safety current range when performing the SOC equalization to the parallel battery pack. In the battery module 100, two battery packs having the highest voltage are performed the SOC equalization. The two equalized battery packs are used as a new battery pack unit, and then the new battery pack unit is equalized with another battery pack in the same manner until all the battery packs in the battery module 100 achieve the SOC equalization.

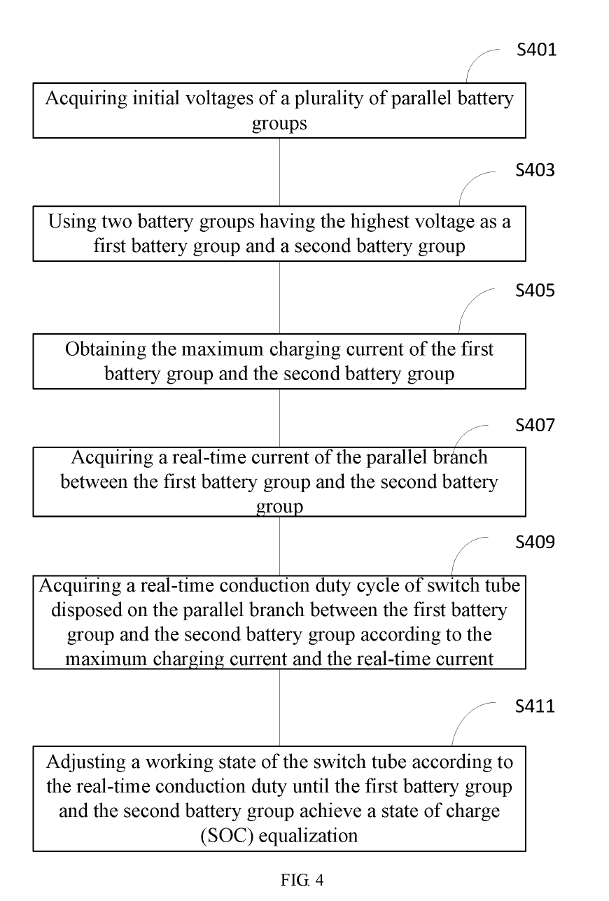

The present disclosure also provides a parallel battery equalization method for performing a SOC equalization to parallel battery packs. As shown in FIG. 4, the parallel battery equalization method includes:

In step S401, initial voltages of a plurality of parallel battery packs are acquired.

In the illustrated embodiment, the initial voltages of the parallel battery packs are acquired, and two parallel battery packs which are performed the SOC equalization firstly are determined according to the acquired voltages.

In step S403, two battery packs having the highest voltage are regarded as a first battery pack and a second battery pack.

The two battery packs having the highest voltage are acquired according to the acquired initial voltages of the battery packs. In an alternative embodiment, the first battery pack and the second battery pack obtained each time may not be the battery pack having the highest voltage.

In the illustrated embodiment, after the step of regarding the two battery packs having the highest voltage as the first battery pack and the second battery pack, the method further includes the following step:

A subtraction operation between the initial voltage of the first battery and an initial voltage of the second battery pack is made, and a ratio operation between a subtraction operation result and an internal resistance of the charged battery pack is made to obtain a third operation value. A ratio operation between the maximum charging current and the third operation value is made to obtain a preset duty cycle of the switch transistor. The switch transistor is conductive at the preset duty cycle, therefore a parallel branch of the first battery pack and the second battery pack is conductive. Specifically, assuming that the initial voltage of the first battery pack is V3, the initial voltage of the second battery pack is V4, and V3 is larger than V4, i.e., the charged battery pack is the second battery pack. The internal resistance of the second battery pack is r2, and the maximum charging current of the second battery pack is I2max. Thus, the preset duty cycle of the switch transistor on the parallel branch of the first battery pack and the second battery pack can be calculated as: a1=I2max/[(V3-V4/r2)].

Alternatively, the preset duty cycle of the switch transistor on the parallel branch of the first battery pack and the second battery pack can also be a preset value. As long as the switch transistor is turned on at the preset value, it is necessary that the current on the parallel branch does not exceed the maximum charging current.

In step S405, the maximum charging current of the first battery pack and the second battery pack is obtained.

After the first battery pack and the second battery pack having the highest voltage are obtained, the battery pack to be charged is determined according to the voltages of the first battery pack and the second battery pack, and the maximum charging current is obtained.

In step S407, a real-time current on the parallel branch between the first battery pack and the second battery pack is acquired.

After the parallel branch between the first battery pack and the second battery pack is conductive, a conduction current value of the parallel branch is timely acquired. In the process of performing the SOC equalization to the first battery pack and the second battery pack, the current on the parallel branch thereof is not a constant value. In the illustrated embodiment, a dynamic current on the parallel branch of the first battery pack and the second battery pack is timely acquired.

In step S409, a real-time conduction duty cycle of the switch transistor disposed on the parallel branch between the first battery pack and the second battery pack is acquired according to the maximum charging current and the real-time current.

The real-time current on the parallel branch of the first battery pack and the second battery pack is acquired during the charging time. The real-time conduction duty cycle of the switch transistor disposed on the parallel branch between the first battery pack and the second battery pack is obtained according to the maximum charging current and the real-time current. In the illustrated embodiment, the step S409 includes: making a ration operation between the maximum charging current and the real-time current to obtain a second operation value; making a product operation between the second operation value and the preset duty cycle of the switch transistor to obtain the real-time conduction duty cycle. Specifically, assuming that the real-time current on the parallel branch is I3, the maximum charging current is I3max, and the preset duty cycle of the switch is a4, thus the real-time conduction duty cycle of the switch of the parallel branch is calculated as: a3=(I3max/I3)*a4.

In step S411, a conductive state of the switch transistor is adjusted according to the real-time conduction duty until the first battery pack and the second battery pack achieve a state of charge (SOC) equalization.

The conductive state of the switch transistor is controlled according to the real-time conduction duty cycle, therefore the conduction current of between the first battery pack and the second battery pack can be adjusted, thereby avoiding the damage of the battery caused by the excessive charging current when performing the SOC equalization to the first battery pack and the second battery pack. In the illustrated embodiment, the conductive state of the switch transistor is continually adjusted according to the real-time conduction duty cycle until the two battery packs achieve a state of charge (SOC) equalization.

After the equalization process is completed, the first battery pack and the second battery pack are regarded as a battery pack unit, and the equalization process is repeated until all the parallel battery packs achieve the SOC equalization.

In the illustrated embodiment, after the SOC equalization of t first battery pack and the second battery pack is completed, the two battery packs will be served as a new battery pack, which will be performed SOC equalization with another battery pack. The process of performing the SOC equalization to is: repeating the equalization process in the battery parallel equalization method again, i.e., repeating steps S401 to S411 until all the parallel battery pack achieve SOC equalization.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

Although the invention is illustrated and described herein with reference to specific embodiments, the invention is not intended to be limited to the details shown. It should be noted that any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A parallel battery equalization device, comprising:
a battery module comprising a plurality of battery packs and a plurality of parallel branches coupled to the battery packs, respectively;
a switch module comprising at least one switch transistor;
a control module comprising at least one pulse width modulation (PWM) drive control circuit; and
a microprocessor;
wherein each switch transistor is coupled to one parallel branch, the parallel branch is conductive when the switch transistor is turned on, and the coupled parallel branch is cut off when the switch transistor is turned off; a control terminal of each switch transistor is electrically coupled to one PWM drive control circuit; and the PWM drive control circuit is configured to control a conduction duty cycle of the switch transistor;
wherein the microprocessor is electrically coupled to each PWM drive control circuit, respectively; the microprocessor is configured to acquire a real-time current of each parallel branch; the microprocessor controls a real-time conduction duty cycle of the switch transistor via the PWM drive control circuit according to the real-time current, such that the real-time current does not exceed a maximum charging current allowed by the battery pack at both ends of the parallel branch.

2. The parallel battery equalization device of claim 1, wherein the microprocessor controls the switch transistor of the corresponding parallel branch to perform an initial conduction at a preset duty cycle via the PWM drive control circuit, such that the microprocessor acquires the real-time current of each parallel branch.

3. The parallel battery equalization device of claim 2, wherein the microprocessor makes a ratio operation between the maximum charging current of the parallel branch and the real-time current of the parallel branch, and multiplies an operation result value and the preset duty cycle to obtain the real-time conduction duty cycle.

4. The parallel battery equalization device of claim 1, further comprising a plurality of inductors, wherein each inductor is coupled to one parallel branch.

5. The parallel battery equalization device of claim 1, wherein the battery module comprises a first battery pack and a second battery pack parallel to the first battery pack; the switch module comprises one switch transistor; the control module comprises one PWM drive control circuit; the switch transistor is coupled to the parallel branch of the battery pack; the PWM drive control circuit is coupled to the control terminal of the switch transistor; the microprocessor is electrically coupled to the PWM drive control circuit; the microprocessor controls the switch to conduct at a preset duty cycle firstly, and then acquires the real-time current of the parallel branch, and makes a ratio operation between the maximum charging current of the parallel branch and the real-time current of the parallel branch to obtain an operation result value, and make a product operation between the operation result value and the preset duty cycle to obtain the real-time conduction duty cycle of the switch; and the microprocessor controls the conduction of the switch transistor via the PWM drive control circuit.

6. The parallel battery equalization device of claim 5, wherein the microprocessor is further configured to acquire an initial voltages of the first battery pack and the second battery pack; the microprocessor makes a subtraction operation between the initial voltages of the first battery and the second battery pack, and make a ratio operation between a subtraction operation result and the internal resistance of the charged battery pack of the parallel branch to obtain a first operation value; the microprocessor makes a ratio operation between the maximum charging current and the first operation value to obtain the preset duty cycle of the switch transistor.

7. The parallel battery equalization device of claim 5, further comprising an inductor, wherein the inductor is coupled to the parallel branch.

8. A parallel battery equalization method, comprising:
acquiring initial voltages of a plurality of parallel battery packs;
regarding two battery packs having the highest voltage as a first battery pack and a second battery pack;
obtaining an maximum charging current allowed by the first battery pack and the second battery pack;
acquiring a real-time current of the parallel branch between the first battery pack and the second battery pack;
acquiring a real-time conduction duty cycle of switch transistor disposed on the parallel branch between the first battery pack and the second battery pack according to the maximum charging current and the real-time current;
adjusting a conductive state of the switch transistor according to the real-time conduction duty until the first battery pack and the second battery pack achieve a state of charge (SOC) equalization; and
regarding the first battery pack and the second battery pack as a battery pack unit, and repeating the aforementioned steps until all the parallel battery packs achieve the SOC equalization.

9. The method of claim 8, wherein the acquiring the real-time conduction duty cycle of the switch transistor disposed on the parallel branch between the first battery pack and the second battery pack according to the maximum charging current and the real-time current comprises:
making a ration operation between the maximum charging current and the real-time current to obtain a second operation value; and
making a product operation between the second operation value and the preset duty cycle of the switch transistor to obtain the real-time conduction duty cycle.

10. The method of the claim 8, wherein after regarding the two battery packs having the highest voltage as the first battery pack and the second battery pack, the method further comprises:
making a subtraction operation between an initial voltage of the first battery pack and an initial voltage of the second battery pack, and make a ratio operation between a subtraction operation result and the internal resistance of the charged battery pack of the parallel branch to obtain a third operation value;
making a ration operation between the maximum charging current and the third operation value to obtain the preset duty cycle of the switch transistor; and
controlling the conduction of the switch transistor according to the preset duty cycle to make the parallel branch of the first battery pack and second battery pack conducted.
